(19) United States
(12) Patent Application Publication
(10) Pub. No.: US 2023/0169315 A1
(43) Pub. Date: Jun. 1, 2023

(54) SPARSE INDEX GENERATOR

(71) Applicant: Intel Corporation, Santa Clara, CA (US)

(72) Inventors: Kamlesh Pillai, Bangalore (IN); Gurpreet Singh Kalsi, Portland, OR (US); Om Ji Omer, Bangalore (IN)

(21) Appl. No.: 17/929,178

(22) Filed: Sep. 1, 2022

(51) Int. Cl. G06N 3/0495

(52) U.S. Cl. CPC G06N 3/0495

(57) ABSTRACT

Systems, apparatuses and methods may provide for technology that generates a vector output based on a bitmask, wherein the vector output includes non-zero bit indices in a first portion of the vector output, and wherein the non-zero bit indices correspond to non-zero values in the bitmask. The technology may also generate an offset based on the bitmask, wherein the offset indicates a start position in the vector output for the non-zero bit indices.

### TECHNICAL FIELD

Embodiments generally relate to artificial intelligence (AI) computing architectures. More particularly, embodiments relate to sparse index generators in AI computing architectures.

### BACKGROUND OF THE DISCLOSURE

Deep neural networks (DNNs) typically have heavy computational requirements/demand. Accordingly, recent developments in DNNs have focused on using pruning and/or quantization techniques to reduce computational requirements, wherein these techniques tend to introduce sparsity (e.g., a large percentage of zeros) in the data to be processed. Conventional solutions may rely on compression of the data into a dense format for storage and the use of non-zero element indices to decompress the data for processing. Solutions that store the non-zero element indices tend to increase memory requirements.

### BRIEF DESCRIPTION OF THE DRAWINGS

The various advantages of the embodiments will become apparent to one skilled in the art by reading the following specification and appended claims, and by referencing the following drawings, in which:

FIG. 1A is a block diagram of an example of an AI data conversion architecture according to an embodiment;

FIG. 1B is an illustration of an example of a vector output with offset according to an embodiment;

FIG. 2 is an illustration of an example of a conventional compressed sparse column operation;

FIG. 3 is an illustration of an example of a conventional bitmask generation operation;

FIGS. 4A and 4B are illustrations of examples of conventional index generator outputs;

FIG. 5 is an illustration of an example of a bitmask generation operation, non-zero count hardware and a sparse index generator according to an embodiment;

FIG. 6 is a schematic diagram of an example of a bitmask decoder according to an embodiment;

FIG. 7 is a schematic diagram of an example of parallel index generation hardware according to an embodiment;

FIG. 8 is a flowchart of an example of a method of decoding a bitmask according to an embodiment;

FIG. 9 is a flowchart of an example of a method of decoding a bitmask in parallel according to an embodiment;

FIG. 10 is a block diagram of an example of a performance-enhanced computing system according to an embodiment;

FIG. 11 is an illustration of an example of a semiconductor package apparatus according to an embodiment;

FIG. 12 is a block diagram of an example of a processor according to an embodiment; and

FIG. 13 is a block diagram of an example of a multi-processor based computing system according to an embodiment.

### DETAILED DESCRIPTION

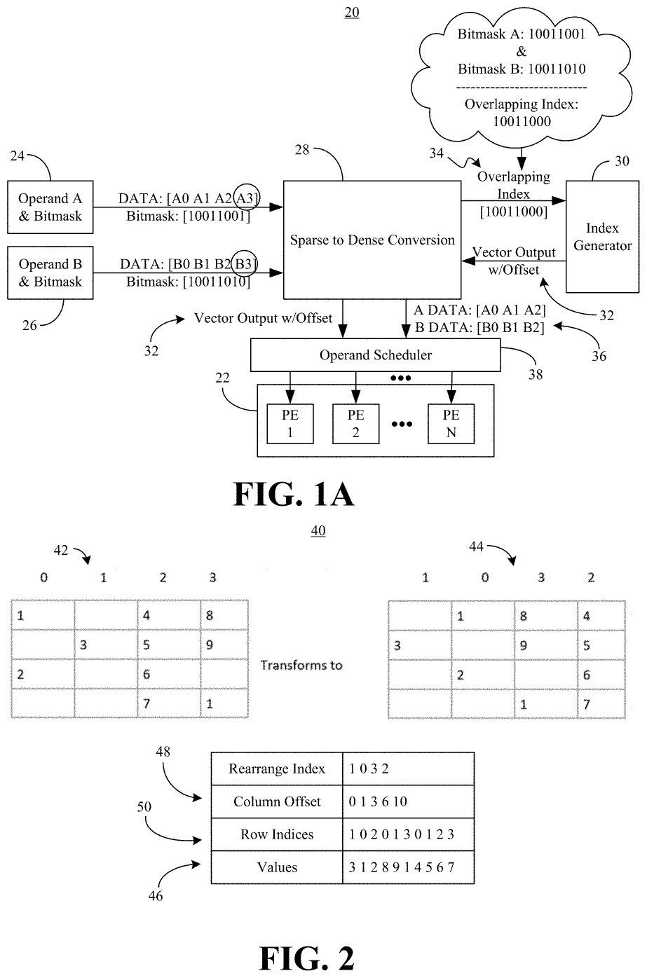

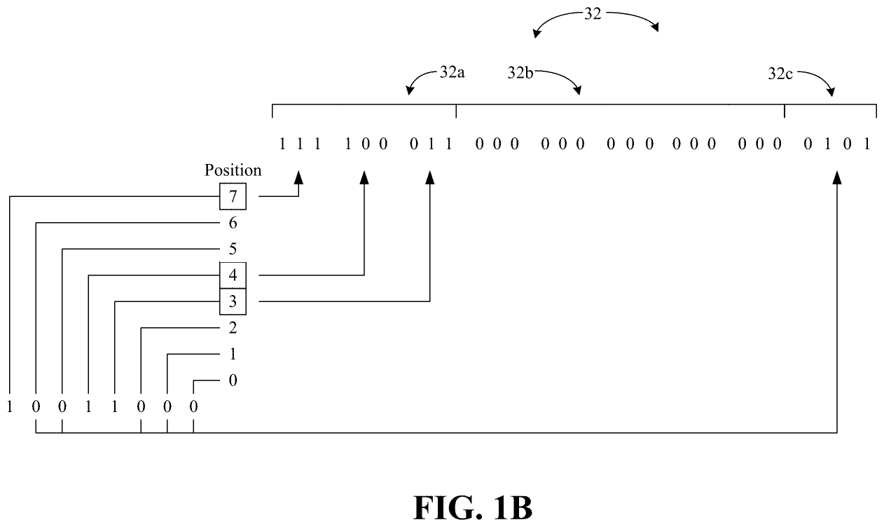

FIG. 1A shows an AI data conversion architecture 20 in which a plurality of processing elements (PEs) 22 are to operate on a first operand 24 (“Operand A”) having a corresponding bitmask and a second operand 26 (“Operand B”) having a corresponding bitmask. For example, the PEs 22 might multiply data in the first operand 24 by data in the second operand 26 to obtain a computational result, wherein the bitmasks indicate the positions of non-zero values/elements in the operands 24, 26. Thus, the matrix multiplication in the illustrated example, might involve multiplying A0 with B0, multiplying A1 with B1, multiplying A2 with B2, multiplying zero with B3, and multiplying A3 with zero. Because elements A3 and B3 are non-overlapping and will not contribute to the computational result, those elements may be dropped from the operations conducted by the PEs 22. In such a case, a sparse to dense converter 28 generates an overlapping index 34 (e.g., bitmask for processing) based on the bitmasks and issues the overlapping index 34 to an index generator 30.

With continuing reference to FIGS. 1A and 1B, the illustrated index generator 30 may generate a vector output 32 (32a-32c) based on the overlapping index 34. In an embodiment, the vector output 32 includes non-zero bit indices in a first (e.g., leftmost) portion 32a of the vector output 32 and zeros in a second (e.g., rightmost) portion 32b of the vector output 32, wherein the non-zero bit indices correspond to non-zero values in the overlapping index 34. The index generator may also generate an offset 32c based on the overlapping index 34, wherein the offset 32c indicates a start position in the vector output 32 for the non-zero bit indices. Accordingly, the converter 28 may issue a compressed version 36 of the data to be processed along with the vector output 32 and offset to an operand scheduler 38, which may scale the number of PE's 22 to increase compute capacity (e.g., supplying dense data to skip zero processing).

Storing the vector output 32 (e.g., the indices of non-zero elements) grows with the increase in non-zero elements. This increase can occupy a significant portion of memory in the case of larger networks. Accordingly, embodiments bypass storage of the vector output 32 and the offset. Additionally, the generation of the vector output 32 and the offset is relatively fast (e.g., on a per bitmask iteration basis in a single cycle) without incurring a high penalty of area, which in turn avoids underutilization of resources.

Turning now to FIG. 2, current implementations in commercial accelerators may employ a dense two-dimensional (2D) array optimized for a fixed size of an input matrix 42. Such implementations may rely on (de) compression of sparse data in a dense format. Some known solutions that are widely used for (de) compression of sparse data in a dense format are CSR (compressed sparse row) and CSC (compressed sparse column), which store the corresponding non-zero indices along with the compressed data that can be used for decompression. For example, a CSC operation 40 is shown in which the input matrix 42 is transformed into an output matrix 44. In the illustrated example, a column offset 48 indicates how many elements are present in a cumulative way starting from the top left in column wise order, row indices 50 represent an element row index, and values 46 are the original values of the elements. Traditionally, only non-zero values 46 are stored in memory along with the respective column offset 48 and the row indices 50 (e.g., row offset and column indices in case of CSR). Storage of the row indices 50 grows with the number of non-zero values 46 and vector size. For applications with larger neural networks, the row indices 50 occupy a significant amount of space in memory. Solutions such as direct indexing and step indexing provide only one index per operation, which may lead to underutilization of resources.

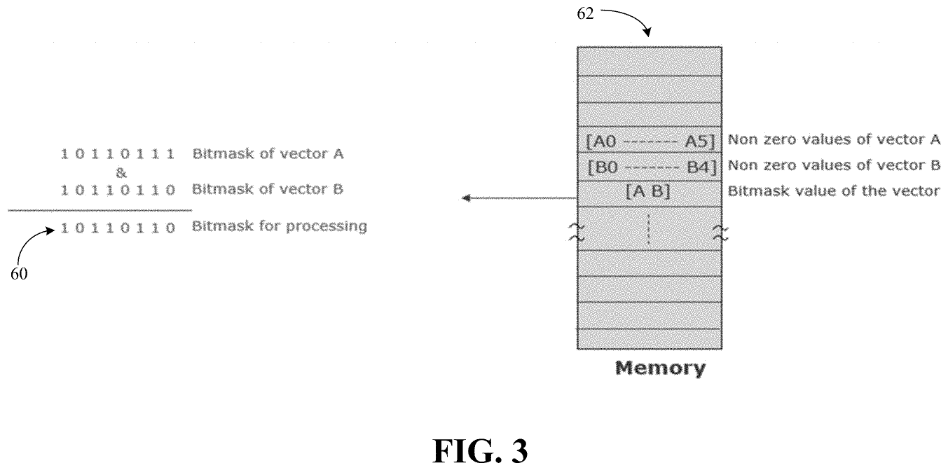

FIG. 3 demonstrates that other conventional solutions may handle the increasing storage requirement by using a bitmask 60 to encode the non-zero values and finding the required indices of the elements contributing to the outcome. This approach saves a significant amount of space in memory 62 but may be relatively slow and therefore suffer from resource underutilization. The non-zero index generation can be increased to match the hardware throughput but may require a significant amount of area due to hardware scaling.

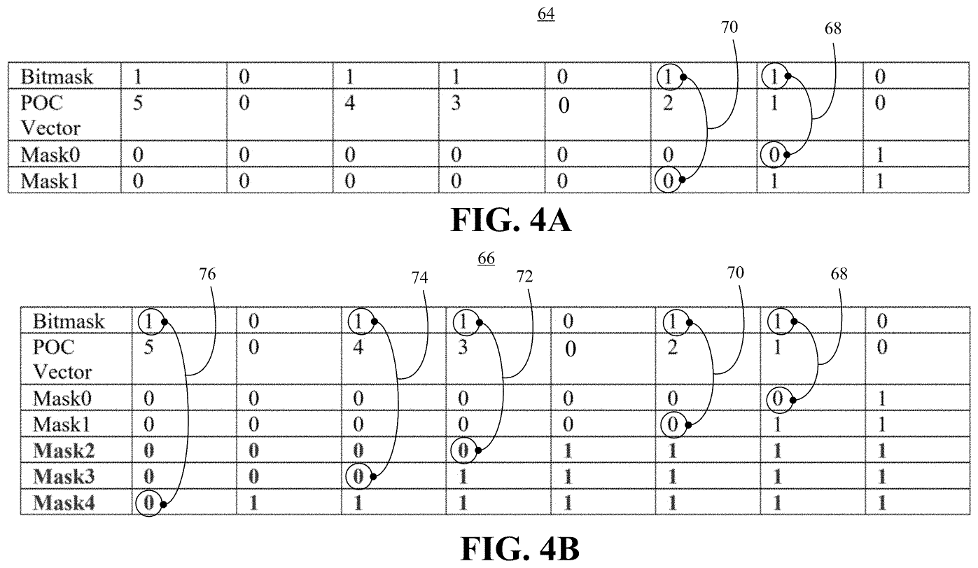

For example, FIGS. 4A and 4B show that “N” masks will be generated for finding indices of N non-zero values in a vector in one iteration/cycle. More particularly, the mask generation process involves bit wise addition by masking the previously found valid index, which also involves bitwise addition and the use of supporting logic. While such an approach may be acceptable for a minimal number of non-zero elements, hardware requirements grow with a reduction in sparsity.

For example, a data structure 64 for a proof of concept (POC) vector may include two parallel vectors (“Mask0” and “Mask1”) for a bitmask of 10110110 to be processed (e.g., after performing an AND operation between bitmasks A and B). In the illustrated example, Mask0 signals a first non-zero position 68 in the bitmask and Mask1 signals a second non-zero position 70 in the bitmask. As best shown in FIG. 4B, Mask2 signals a third non-zero position 72 in the bitmask, Mask3 signals a fourth non-zero position 74 in the bitmask, and Mask4 signals a fifth non-zero position 76 in the bitmask. Thus, hardware cost grows linearly with the number of non-zero elements in the illustrated solution as each non-zero element in a vector involves the generation of one mask.

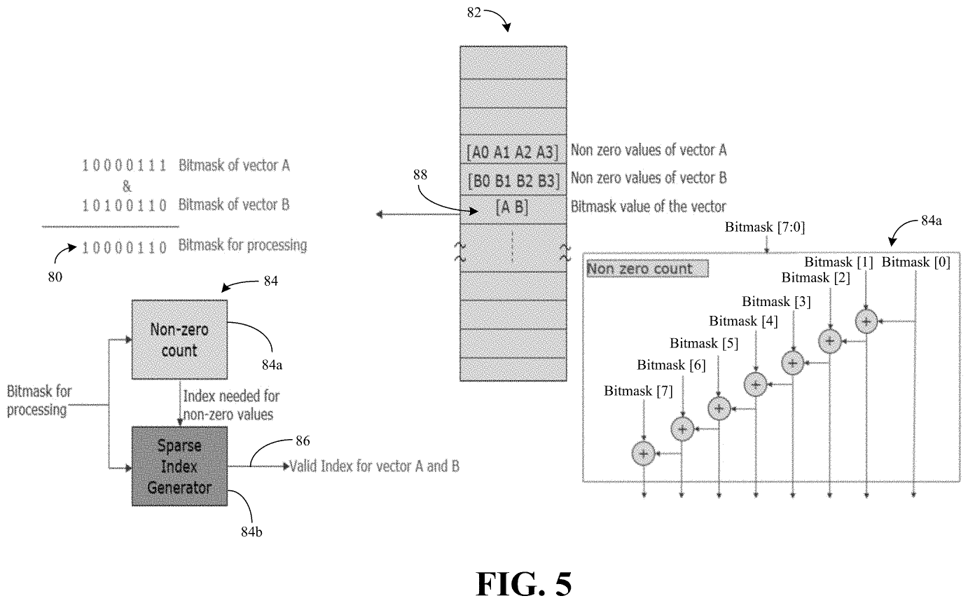

Turning now to FIG. 5, an enhanced solution is shown in which a bitmask 80 is used to encode the non-zero values, which saves a significant amount of space in memory 82. Rather than using a relatively slow approach to finding the required indices of the elements contributing to the outcome, a bitmask decoder 84 (84a, 84b) uses non-zero count hardware 84a and a sparse index generator 84b to create a valid index 86 (e.g., vector output with offset) for vectors involved in a matrix operation.

The bitmask decoder 84 can generate indices of all non-zero elements in the bitmask 80 without storing the indices in the memory 82. For compression, the sparse data is encoded into a bitmask value 88 (e.g., dense bitmask) representing one bit per element of the bitmask 80, wherein the bitmask value 88 is stored in the memory 82 along with the non-zero elements. For decompression of sparse data, the bitmask value 88 may be divided/partitioned into multiple segments, with the segments being decoded in parallel and the indices of each segment being combined using shift operations. The division of the bitmask value 88 provides a flexibility to scale the hardware for any vector size. In one example, decoding of the bitmask value 88 is achieved using a chained multiplexer (mux) structure along with bit wise addition operations. The final output provides a vector (e.g., vector output) with all indices of non-zero elements and an offset to indicate where the indices start in the array. Accordingly, the number of indices can be read from the vector output vector and used based on the compute requirement.

More particularly, elements of vector A have non-zero elements A0, A1, A2 and A3 at locations 0, 1, 2 and 7 of the vector, respectively. Similarly, for vector B non-zero elements B0, B1, B2 and B3 are at locations 1, 2, 5 and 7 of the vector, respectively. To determine the match between the two operands that will contribute to the outcome, the two operand are AND′ ed together to generate the bitmask 80. The non-zero count hardware 84a counts the number of ones in the bitmask 80 for processing. These values are passed to the sparse index generator 84b to obtain the valid index 86 values of A and B that will contribute to the final outcome.

In general, the illustrated solution enables hardware to scale depending on how many non-zero elements are involved based on available compute resources, without increasing latency. The illustrated solution also does not incur any additional memory storage costs and provides a faster solution compared to CSR and CSC, without storing the non-zero indices in the memory 82. The illustrated solution also solves the underutilization issues caused due to slower index generation (e.g., two index generation/cycle case), direct indexing and step indexing solutions with low latency advantages. Additionally, the illustrated solution does not depend on the number of non-zero elements in the bitmask 80. Rather, the solution involves overall two adder structures and a mux chain to obtain indices of all non-zero elements in the bitmask 80. In an embodiment, this hardware requires a minimal increase in synthesis gates.

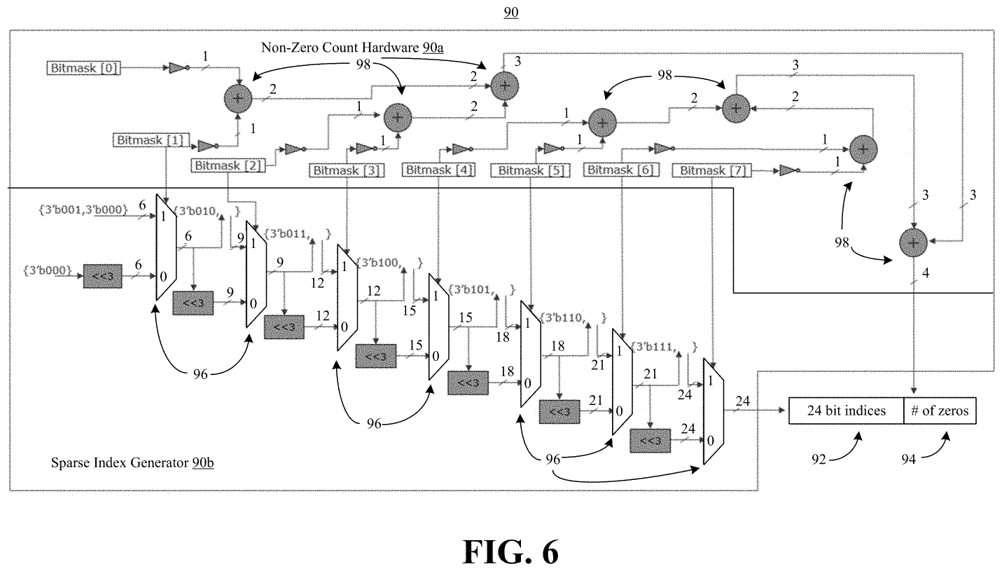

FIG. 6 shows a bitmask decoder 90 (90a, 90b) for an 8-bit bitmask. The illustrated bitmask decoder 90 includes a sparse index generator 90b that determines the indices of all non-zero elements in the bitmask using a mux chain 96. The number of bits in the mux chain 96 output grows from left to right, wherein the pin of each mux represents a bit in the bitmask. During operation, if a zero value is encountered, the previous index is shifted towards the left of a vector output 92 and the vector output 92 is padded with zeros. By contrast, if a non-zero value is encountered, the current index is padded with the previous index at the least significant bit (LSB). Thus, the vector output 92 includes non-zero bit indices in a first (e.g., leftmost) portion of the vector output 92 and zeros in a second (e.g., rightmost) portion of the vector output 92.

Non-zero count hardware 90a uses a plurality of adders 98 to add all ones (zeros) and determine the number of zeros in the bitmask. This number of zeros acts as an offset 94 to start reading non-zero indices in the vector output 92 generated by the sparse index generator 90b.

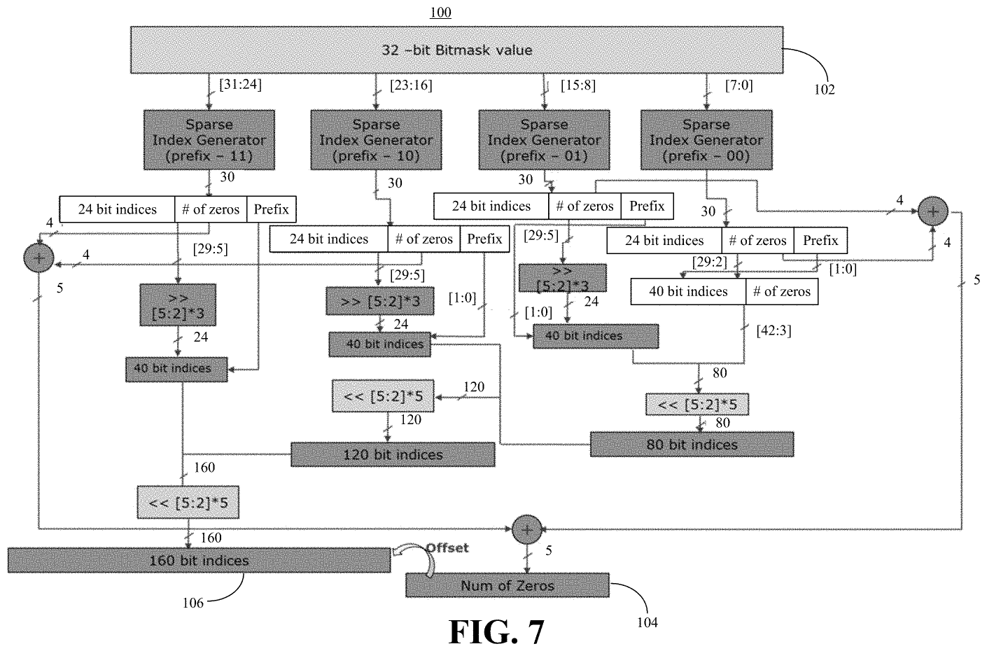

FIG. 7 demonstrates that for a relatively large bitmask 102 (e.g., 32-bit), the bitmask decoder 90 (FIG. 6) can be concatenated to form parallel index generation hardware 100. In the illustrated example, the 32-bit bitmask 102 is divided/partitioned into four segments of 8-bit values and non-zero indices are computed in each 8-bit segment in parallel. Prefix values may be used to keep track of which segment represents which part of the 32-bit bitmask 102. The main principle in concatenating the indices is same as the 8-bit example—all the non-zero indices are shifted towards the left and zeros are moved towards right of the final vector. The parallel index generation hardware 100 also adds all zero counts to obtain a final count of zeros that acts as an offset 104 to start reading non-zero indices in a final vector output 106.

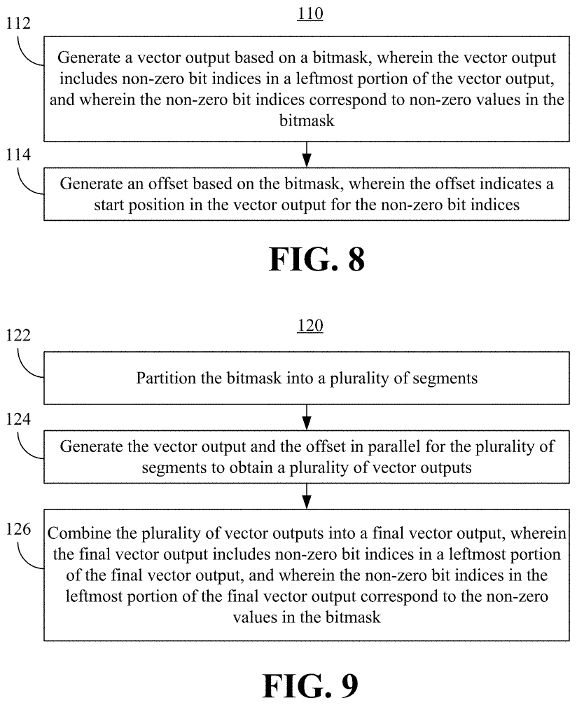

FIG. 8 shows a method 120 of decoding a bitmask. The method 120 may be implemented in hardware such as, for example, the index generator 30 (FIG. 1A), the bitmask decoder 84 (FIG. 5), the bitmask decoder 90 (FIG. 6) and/or the parallel index generation hardware 100 (FIG. 7), already discussed. Additionally, the method 120 may be implemented in one or more modules as a set of logic instructions stored in a machine—or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 110 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 112 provides for generating a vector output based on a bitmask, wherein the vector output includes non-zero bit indices in a first portion of the vector output, and wherein the non-zero bit indices correspond to non-zero values in the bitmask. In one example, the vector output further includes zeros in a second portion of the vector output. Moreover, block 112 may generate the vector output via a multiplexer chain. Block 114 generates an offset based on the bitmask, wherein the offset indicates a start position in the vector output for the non-zero bit indices. In an embodiment, block 114 includes counting a number of zeros in the bitmask. Moreover, block 114 may generate the offset via a plurality of adders. In one example, the method 110 generates the vector output and the offset on a per bitmask iteration basis. Additionally, the method 110 may bypass a storage of the vector output and the offset.

The method 110 therefore enhances performance at least to the extent that the vector output and the offset identify non-zero elements with minimum latency. The method 110 also enhances performance by reducing memory usage/area, improving compute resource utilization and/or decreasing power consumption.

FIG. 9 shows a method 120 of decoding a bitmask in parallel. The method 120 may generally be implemented in conjunction with the method 110 (FIG. 8), already discussed, in hardware such as, for example, the index generator 30 (FIG. 1A), the bitmask decoder 84 (FIG. 5), the bitmask decoder 90 (FIG. 6) and/or the parallel index generation hardware 100 (FIG. 7), already discussed. The method 120 may also be implemented in one or more modules as a set of logic instructions stored in a machine- or computer-readable storage medium RAM, ROM, PROM, firmware, flash memory, etc., in hardware, or any combination thereof. For example, hardware implementations may include configurable logic, fixed-functionality logic, or any combination thereof. Examples of configurable logic (e.g., configurable hardware) include suitably configured PLAs, FPGAs, CPLDs, and general purpose microprocessors. Examples of fixed-functionality logic (e.g., fixed-functionality hardware) include suitably configured ASICs, combinational logic circuits, and sequential logic circuits. The configurable or fixed-functionality logic can be implemented with CMOS logic circuits, TTL logic circuits, or other circuits.

Illustrated processing block 122 provides for partitioning the bitmask into a plurality of segments. Block 124 generates the vector output and the offset in parallel for the plurality of segments to obtain a plurality of vector outputs. In an embodiment, block 126 combines the plurality of vector outputs into a final vector output, wherein the final vector output includes non-zero bit indices in a first portion of the final vector output. In the illustrated example, the non-zero bit indices in the first portion of the final vector output correspond to the non-zero values in the bitmask.

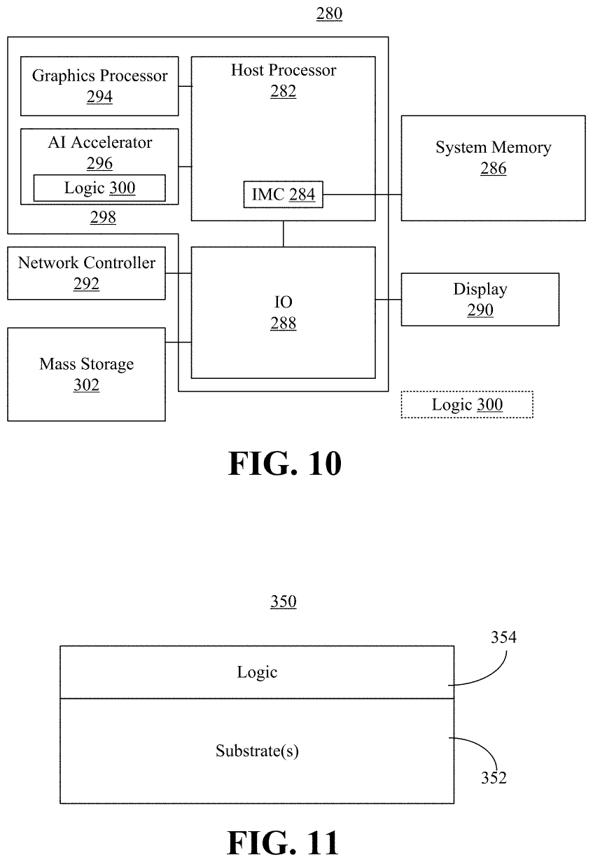

Turning now to FIG. 10, a performance-enhanced computing system 280 is shown. The system 280 may generally be part of an electronic device/platform having computing functionality (e.g., personal digital assistant/PDA, notebook computer, tablet computer, convertible tablet, server, datacenter), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 into a system on chip (SoC) 298.

In an embodiment, the AI accelerator 296 includes logic 300 to perform one or more aspects of the method 110 (FIG. 8) and/or the method 120 (FIG. 9), already discussed. Thus, the logic 300 may generate a vector output based on a bitmask, wherein the vector output includes non-zero bit indices in a first portion of the vector output. Additionally, the non-zero bit indices correspond to non-zero values in the bitmask. The logic 300 may also generate an offset based on the bitmask, wherein the offset indicates a start position in the vector output for the non-zero bit indices. The computing system 280 is therefore performance-enhanced at least to the extent that the vector output and the offset identify non-zero elements with minimum latency. The logic 300 also enhances performance by reducing memory usage/area, improving compute resource utilization and/or decreasing power consumption. Although the logic 300 is shown within the AI accelerator 296, the logic 300 may reside elsewhere in the computing system 280.

FIG. 11 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 110 (FIG. 8) and/or the method 120 (FIG. 9), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

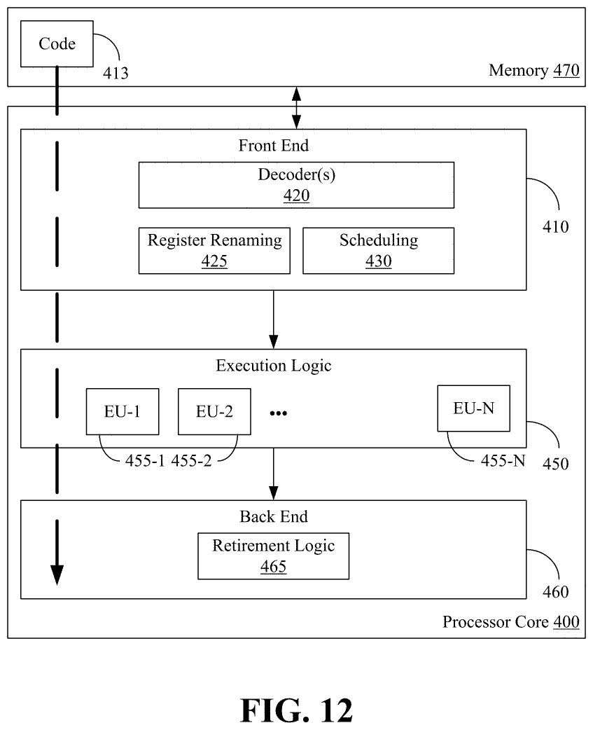

FIG. 12 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 12, a processing element may alternatively include more than one of the processor core 400 illustrated in FIG. 12. The processor core 400 may be a single-threaded core or, for at least one embodiment, the processor core 400 may be multithreaded in that it may include more than one hardware thread context (or “logical processor”) per core.

FIG. 12 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 110 (FIG. 8) and/or the method 120 (FIG. 9), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 12, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

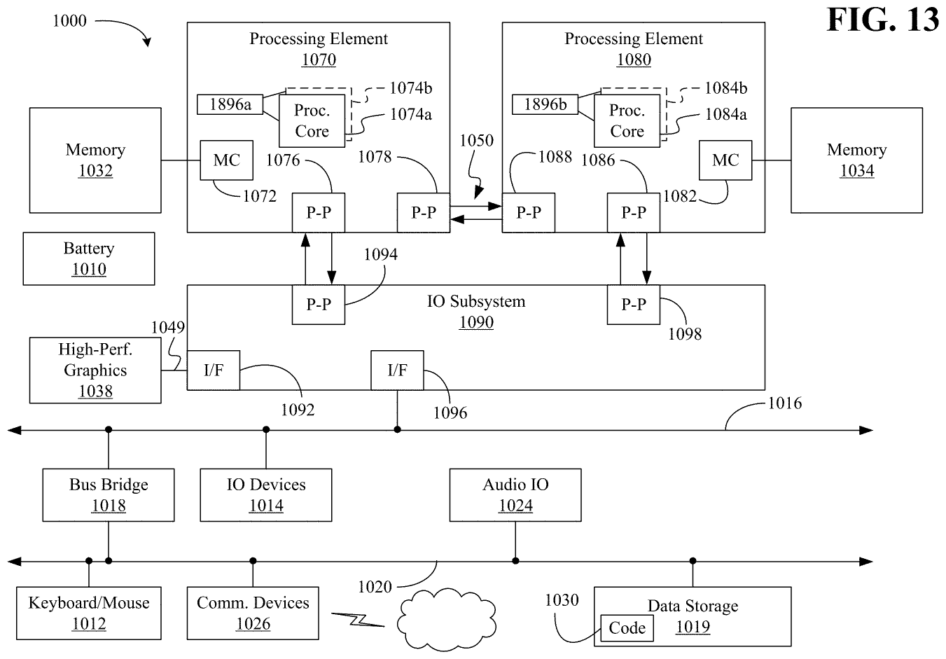

Referring now to FIG. 13, shown is a block diagram of a computing system 1000 embodiment in accordance with an embodiment. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIG. 13, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 13, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 13, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement method 110 (FIG. 8) and/or the method 120 (FIG. 9), already discussed. Further, an audio I/O 1024 may be coupled to second bus 1020 and a battery 1010 may supply power to the computing system 1000.

Note that other embodiments are contemplated. For example, instead of the point-to-point architecture of FIG. 13, a system may implement a multi-drop bus or another such communication topology. Also, the elements of FIG. 13 may alternatively be partitioned using more or fewer integrated chips than shown in FIG. 13.

### Additional Notes and Examples

Example 1 includes a performance-enhanced computing system comprising a converter to generate a bitmask and an index generator coupled to the converter, wherein the index generator includes logic coupled to one or more substrates, the logic to generate a vector output based on the bitmask, wherein the vector output includes non-zero bit indices in a first portion of the vector output, and wherein the non-zero bit indices correspond to non-zero values in the bitmask, and generate an offset based on the bitmask, wherein the offset indicates a start position in the vector output for the non-zero bit indices, and a plurality of processing elements to operate on a plurality of input vectors based on the vector output and the offset.

Example 2 includes the computing system of Example 1, wherein the logic is further to partition the bitmask into a plurality of segments, generate the vector output and the offset in parallel for the plurality of segments to obtain a plurality of vector outputs, and combine the plurality of vector outputs into a final vector output, wherein the final vector output includes non-zero bit indices in a first portion of the final vector output, and wherein the non-zero bit indices in the first portion of the final vector output correspond to the non-zero values in the bitmask.

Example 3 includes the computing system of Example 1, wherein the vector output further includes zeros in a second portion of the vector output.

Example 4 includes the computing system of Example 1, wherein the logic includes a multiplexer chain to generate the vector output.

Example 5 includes the computing system of Example 1, wherein to generate the offset, the logic is to count a number of zeros in the bitmask.

Example 6 includes the computing system of Example 1, wherein the logic includes a plurality of adders to generate the offset.

Example 7 includes the computing system of Example 1, wherein the vector output and the offset are to be generated on a per bitmask iteration basis.

Example 8 includes the computing system of any one of Examples 1 to 7, wherein the logic is further to bypass a storage of the vector output and the offset.

Example 9 includes a semiconductor apparatus comprising one or more substrates, and logic coupled to the one or more substrates, wherein the logic is implemented at least partly in one or more of configurable or fixed-functionality hardware, the logic to generate a vector output based on a bitmask, wherein the vector output includes non-zero bit indices in a first portion of the vector output, and wherein the non-zero bit indices correspond to non-zero values in the bitmask, and generate an offset based on the bitmask, wherein the offset indicates a start position in the vector output for the non-zero bit indices.

Example 10 includes the semiconductor apparatus of Example 9, wherein the logic is further to partition the bitmask into a plurality of segments, generate the vector output and the offset in parallel for the plurality of segments to obtain a plurality of vector outputs, and combine the plurality of vector outputs into a final vector output, wherein the final vector output includes non-zero bit indices in a first portion of the final vector output, and wherein the non-zero bit indices in the first portion of the final vector output correspond to the non-zero values in the bitmask.

Example 11 includes the semiconductor apparatus of Example 9, wherein the vector output further includes zeros in a second portion of the vector output.

Example 12 includes the semiconductor apparatus of Example 9, wherein the logic includes a multiplexer chain to generate the vector output.

Example 13 includes the semiconductor apparatus of Example 9, wherein to generate the offset, the logic is to count a number of zeros in the bitmask.

Example 14 includes the semiconductor apparatus of Example 9, wherein the logic includes a plurality of adders to generate the offset.

Example 15 includes the semiconductor apparatus of Example 9, wherein the vector output and the offset are to be generated on a per bitmask iteration basis.

Example 16 includes the semiconductor apparatus of any one of Examples 9 to 15, wherein the logic is further to bypass a storage of the vector output and the offset.

Example 17 includes the semiconductor apparatus of any one of Examples 9 to 16, wherein the logic coupled to the one or more substrates includes transistor channel regions that are positioned within the one or more substrates.

Example 18 includes a method of operating a performance-enhanced computing system, the method comprising generating a vector output based on a bitmask, wherein the vector output includes non-zero bit indices in a first portion of the vector output, and wherein the non-zero bit indices correspond to non-zero values in the bitmask, and generating an offset based on the bitmask, wherein the offset indicates a start position in the vector output for the non-zero bit indices.

Example 19 includes the method of Example 18, further including partitioning the bitmask into a plurality of segments, generating the vector output and the offset in parallel for the plurality of segments to obtain a plurality of vector outputs, and combining the plurality of vector outputs into a final vector output, wherein the final vector output includes non-zero bit indices in a first portion of the final vector output, and wherein the non-zero bit indices in the first portion of the final vector output correspond to the non-zero values in the bitmask.

Example 20 includes the method of Example 18, wherein the vector output further includes zeros in a second portion of the vector output.

Example 21 includes the method of Example 18, wherein the vector output is generated via a multiplexer chain.

Example 22 includes the method of Example 18, wherein generating the offset includes counting a number of zeros in the bitmask.

Example 23 includes the method of Example 18, wherein the offset is generated via a plurality of adders.

Example 24 includes the method of Example 18, wherein the vector output and the offset are generated on a per bitmask iteration basis.

Example 25 includes the method of any one of Examples 18 to 24, further including bypassing a storage of the vector output and the offset.

Example 26 includes an apparatus comprising means for performing the method of any one of Examples 18 to 25.

The technology described herein therefore finds the indices of all non-zero elements for sparse DNN applications with minimum (e.g., single cycle) latency without storing the indices in the memory. The technology therefore also utilizes compute resources to the fullest extent. Further, this capability is achieved without encountering a negative impact in terms of performance, area and/or power.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a converter to generate a bitmask;
an index generator coupled to the converter, wherein the index generator includes logic coupled to one or more substrates, the logic to:
generate a vector output based on the bitmask, wherein the vector output includes non-zero bit indices in a first portion of the vector output, and wherein the non-zero bit indices correspond to non-zero values in the bitmask, and
generate an offset based on the bitmask, wherein the offset indicates a start position in the vector output for the non-zero bit indices; and
a plurality of processing elements to operate on a plurality of input vectors based on the vector output and the offset.

2. The computing system of claim 1, wherein the logic is further to:
partition the bitmask into a plurality of segments,
generate the vector output and the offset in parallel for the plurality of segments to obtain a plurality of vector outputs, and
combine the plurality of vector outputs into a final vector output, wherein the final vector output includes non-zero bit indices in a first portion of the final vector output, and wherein the non-zero bit indices in the first portion of the final vector output correspond to the non-zero values in the bitmask.

3. The computing system of claim 1, wherein the vector output further includes zeros in a second portion of the vector output.

4. The computing system of claim 1, wherein the logic includes a multiplexer chain to generate the vector output.

5. The computing system of claim 1, wherein to generate the offset, the logic is to count a number of zeros in the bitmask.

6. The computing system of claim 1, wherein the logic includes a plurality of adders to generate the offset.

7. The computing system of claim 1, wherein the vector output and the offset are to be generated on a per bitmask iteration basis.

8. The computing system of claim 1, wherein the logic is further to bypass a storage of the vector output and the offset.

9. A semiconductor apparatus comprising:
one or more substrates; and
logic coupled to the one or more substrates, wherein the logic is implemented at least partly in one or more of configurable or fixed-functionality hardware, the logic to:
generate a vector output based on a bitmask, wherein the vector output includes non-zero bit indices in a first portion of the vector output, and wherein the non-zero bit indices correspond to non-zero values in the bitmask; and
generate an offset based on the bitmask, wherein the offset indicates a start position in the vector output for the non-zero bit indices.

10. The semiconductor apparatus of claim 9, wherein the logic is further to:
partition the bitmask into a plurality of segments;
generate the vector output and the offset in parallel for the plurality of segments to obtain a plurality of vector outputs; and
combine the plurality of vector outputs into a final vector output, wherein the final vector output includes non-zero bit indices in a first portion of the final vector output, and wherein the non-zero bit indices in the first portion of the final vector output correspond to the non-zero values in the bitmask.

11. The semiconductor apparatus of claim 9, wherein the vector output further includes zeros in a second portion of the vector output.

12. The semiconductor apparatus of claim 9, wherein the logic includes a multiplexer chain to generate the vector output.

13. The semiconductor apparatus of claim 9, wherein to generate the offset, the logic is to count a number of zeros in the bitmask.

14. The semiconductor apparatus of claim 9, wherein the logic includes a plurality of adders to generate the offset.

15. The semiconductor apparatus of claim 9, wherein the vector output and the offset are to be generated on a per bitmask iteration basis.

16. The semiconductor apparatus of claim 9, wherein the logic is further to bypass a storage of the vector output and the offset.

17. The semiconductor apparatus of claim 9, wherein the logic coupled to the one or more substrates includes transistor channel regions that are positioned within the one or more substrates.

18. A method comprising:
generating a vector output based on a bitmask, wherein the vector output includes non-zero bit indices in a first portion of the vector output, and wherein the non-zero bit indices correspond to non-zero values in the bitmask; and
generating an offset based on the bitmask, wherein the offset indicates a start position in the vector output for the non-zero bit indices.

19. The method of claim 18, further including:
partitioning the bitmask into a plurality of segments;
generating the vector output and the offset in parallel for the plurality of segments to obtain a plurality of vector outputs; and
combining the plurality of vector outputs into a final vector output, wherein the final vector output includes non-zero bit indices in a first portion of the final vector output, and wherein the non-zero bit indices in the first portion of the final vector output correspond to the non-zero values in the bitmask.

20. The method of claim 18, wherein the vector output further includes zeros in a second portion of the vector output.

21. The method of claim 18, wherein the vector output is generated via a multiplexer chain.

22. The method of claim 18, wherein generating the offset includes counting a number of zeros in the bitmask.

23. The method of claim 18, wherein the offset is generated via a plurality of adders.

24. The method of claim 18, wherein the vector output and the offset are generated on a per bitmask iteration basis.

25. The method of claim 18, further including bypassing a storage of the vector output and the offset.
